(19) United States
(12) Patent Application Publication
(10) Pub. No.: US 2019/0123487 A1
(43) Pub. Date: Apr. 25, 2019

(54) CIRCULAR CONNECTORS

(71) Applicant: Conesys, Inc., Torrance, CA (US)

(72) Inventor: Raymond J. Norland, Torrance, CA (US)

(21) Appl. No.: 15/790,661

(22) Filed: Oct. 23, 2017

(51) Int. Cl. H01R 13/639; H01R 13/622; H01R 43/18

(52) U.S. Cl. CPC H01R 13/639; H01R 43/18; H01R 13/622

(57) ABSTRACT

Electrical connectors and methods for manufacturing, assembling, and using the same are disclosed. The electrical connectors can include a first shell, a second shell, a coupling nut, and a locking ring. The electrical connectors can also include an anti-decoupling mechanism intermediate the coupling nut and one of the shells. The anti-decoupling mechanism can include a plurality of detent assemblies equidistantly-spaced around the electrical connector. The anti-decoupling mechanism can also include a grooved surface comprising a plurality of axial grooves, and each groove can define a constant radius of curvature from end to end. The anti-decoupling mechanism be four-fold rotationally symmetric about a first axis and reflectively symmetric about a second axis and a third axis, wherein the first axis, the second axis, and the third axis are mutually orthogonal.

### BACKGROUND

The present disclosure relates to circular connectors for electrical contacts and methods for manufacturing, assembling, and using the same.

### BRIEF DESCRIPTION OF THE FIGURES

Various features of the embodiments described herein, together with advantages thereof, may be understood in accordance with the following description taken in conjunction with the accompanying drawings as follows:

FIG. 1 is a perspective view of a circular connector for electrical contacts according to various embodiments of the present disclosure.

FIG. 2 is an exploded perspective view of the circular connector of FIG. 1 according to various embodiments of the present disclosure.

FIG. 3 is an elevation end view of a shell and a coupling nut of the circular connector of FIG. 1 according to various embodiments of the present disclosure.

FIG. 4 is a quarter cross-section, elevation view of the shell and the coupling nut of FIG. 3 taken along the section lines A-A depicted in FIG. 3 according to various embodiments of the present disclosure.

FIG. 5 is a quarter cross-section, exploded elevation view of the shell and the coupling nut of FIG. 3 taken along the section lines A-A depicted in FIG. 3 according to various embodiments of the present disclosure.

FIG. 6 is a perspective view of the shell of FIG. 3 according to various embodiments of the present disclosure.

FIG. 7 is a perspective view of the coupling nut of FIG. 3 according to various embodiments of the present disclosure.

FIG. 8 is a cross-sectional perspective view of the coupling nut and the shell of FIG. 3 taken along the section lines B-B depicted in FIG. 4 according to various embodiments of the present disclosure.

FIG. 9 is a cross-sectional elevation end view of the coupling nut and the shell of FIG. 3 taken along the section lines B-B depicted in FIG. 4 according to various embodiments of the present disclosure.

FIG. 10 is a detail view of a portion of FIG. 9 according to various embodiments of the present disclosure.

FIG. 11 is an exploded elevation view of components of a circular connector according to various embodiments of the present disclosure.

FIG. 12 is a cross-sectional elevation view of the shell and the coupling nut of FIG. 3 in a partially assembled configuration and depicting a locking ring positioned around the shell and further depicting a funnel assembly tool engaged with the coupling nut according to various embodiments of the present disclosure.

Corresponding reference characters indicate corresponding parts throughout the several views. The exemplifications set out herein illustrate various embodiments of the invention, in one form, and such exemplifications are not to be construed as limiting the scope of the invention in any manner.

### DETAILED DESCRIPTION

In various embodiments, a circular connector can include a first shell that houses at least one electrical contact, a second shell that houses at least one corresponding electrical contact, and a coupling nut that is configured to secure the first shell and the second shell together to physically connect and electrically couple the electrical contacts housed within the shells. When the first shell and the second shell are assembled together, rotation of the first shell relative to the second shell can be limited and/or prevented. For example, the first shell and the second shell can include alignment features, which prevent rotation of the first shell relative to the second shell. It may be desirable to prevent rotation of the first shell relative to the second shell to maintain the alignment of the electrical contacts and to avoid damage thereto.

In various instances, as the coupling nut rotates in a coupling direction relative to the second shell, the coupling nut can be configured to threadably engage a threaded portion on the first shell to draw the first shell toward the second shell. Moreover, rotation of the coupling nut relative to the second shell can be resisted by an anti-decoupling mechanism located intermediate the coupling nut and the second shell. Circular connectors can be used to connect a variety of different types of electrical contacts and can be used in various environments. When circular connectors are used in high vibration environments, for example, it may be desirable to incorporate an anti-vibration or anti-decoupling mechanism. For example, circular connectors for high-vibration environments may employ a spring-loaded detent and/or ratchet mechanism to prevent and/or limit undesirable rotation, and possible decoupling, of the connector components. Exemplary anti-decoupling mechanisms are described in U.S. Pat. No. 9,531,120 to Bates, III, et al., titled CIRCULAR CONNECTORS, which issued Dec. 27, 2016. U.S. Pat. No. 9,531,120 is incorporated by reference herein in its entirety.

In various instances, it can be desirable to use an anti-decoupling mechanism having improved durability and rotational resistance while being cost effective to manufacture and assemble. Assembling a reduced number of components can be an effective cost reduction strategy. Furthermore, reducing the number of components in an assembly, particularly the number of moving and/or impacted components, can improve the durability of the circular connector. While providing a durable and cost effective solution, the circular connectors described herein can also meet the requirements of MIL-DTL-38999M w/AMENDMENT 1, dated Jan. 26, 2017, including the coupling and decoupling torque requirements thereof. More specifically, the maximum engagement and disengage torque for a circular connector can be between 8 and 40 lbf-in and the minimum disengagement torque can be between 2 and 7 lbf-in depending on the size of the shells. For example, for a shell size number 9, the maximum engagement and disengagement torque can be between 8 lbf-in and the minimum disengagement torque can be 2 lbf-in.

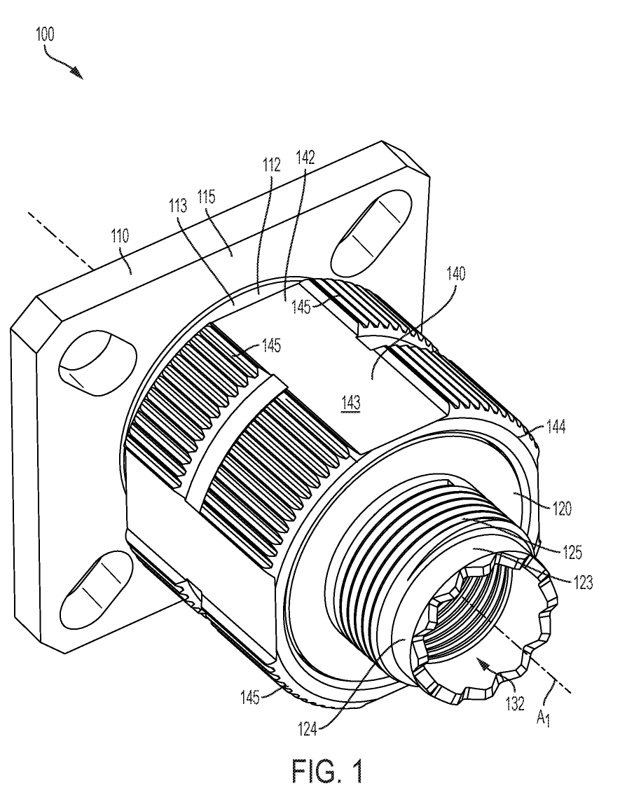

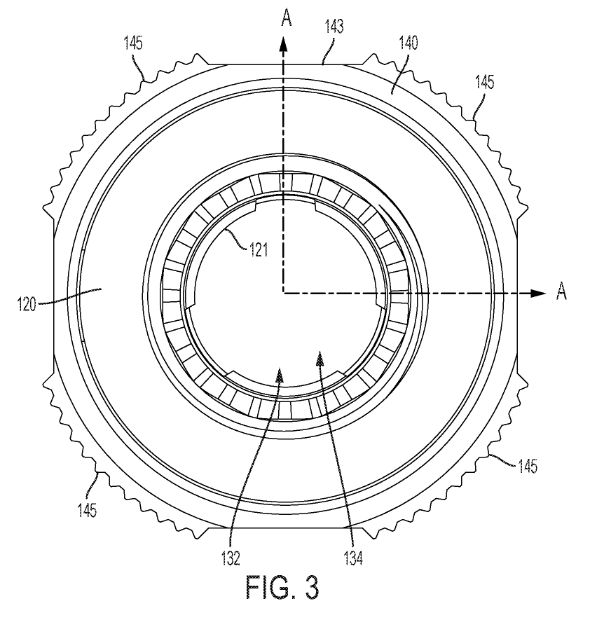

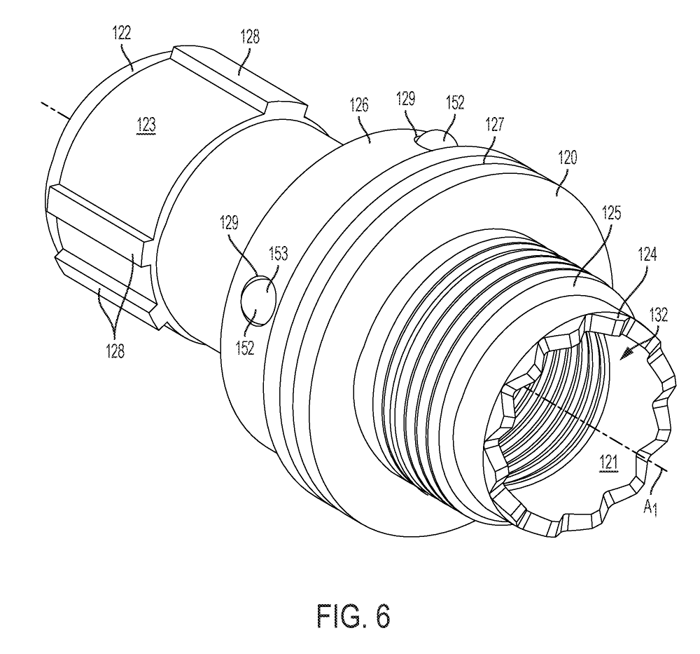

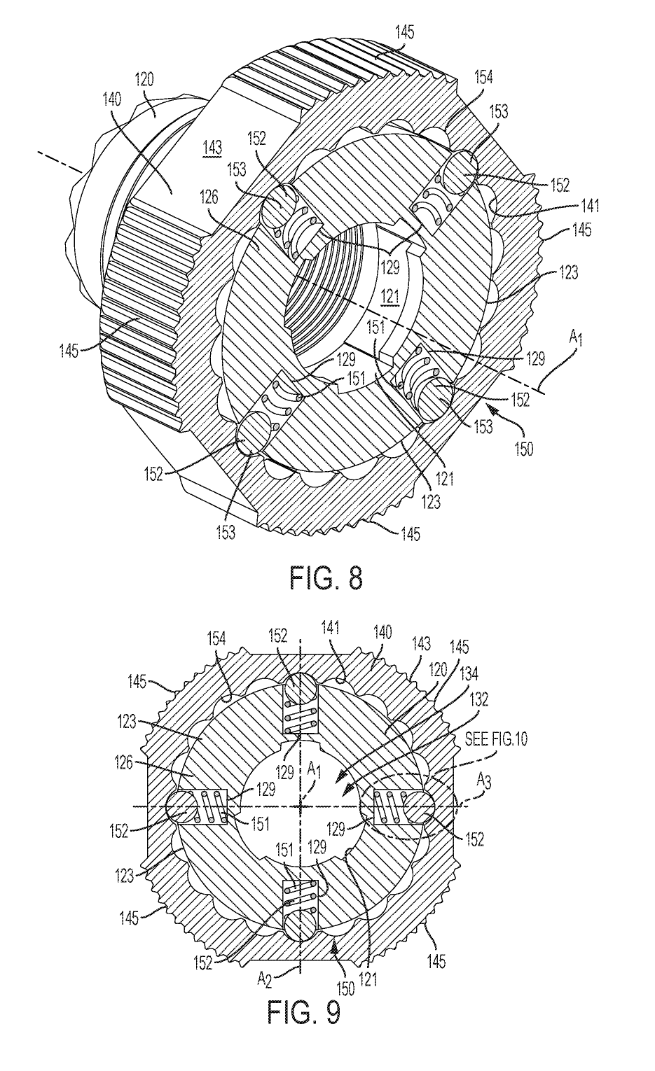

A circular connector 100 and various components thereof are depicted in FIGS. 1-10 and 12. The reader will appreciate that various features illustrated and/or described with respect to the circular connector 100 can be combined with the features of other embodiments. The circular connector 100 includes a first shell 110, a second shell 120, a coupling nut 140, and a locking ring 160. Referring still to FIGS. 1-10, the first shell 110 can form a receptacle shell and the second shell 120 can form a plug shell. Accordingly, the first shell 110 can include an opening or central bore that is structured and dimensioned to receive the second shell 120 therein. In other instances, the first shell 110 can form a plug for the second shell 120, and the second shell 120 can form a receptacle for the first shell 110, for example.

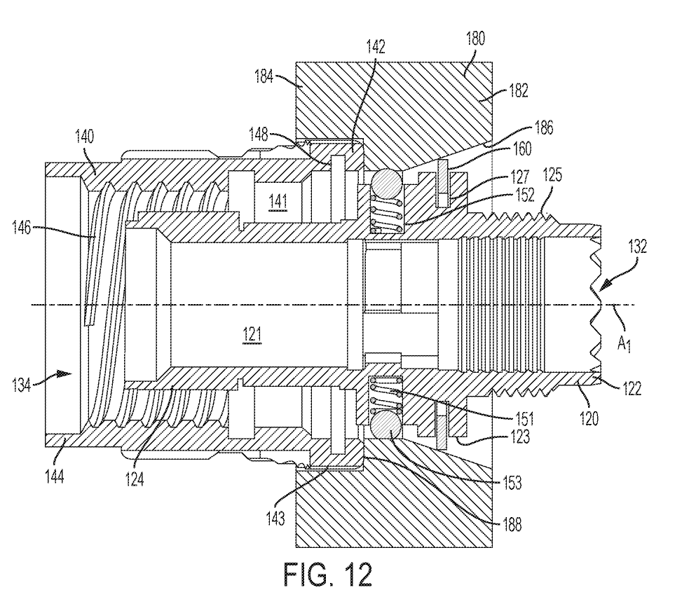

The first shell 110 and the second shell 120 can each include a housing and electrical contacts can be housed therein. For example, the first shell 110 can include a first housing and at least one pin connection housed therein, and the second shell 120 can include a second housing and at least one socket connection housed therein, for example. When fully assembled, the circular connector 100 can physically connect and electrically couple the pin connection(s) housed within the first shell 110 to the socket connection(s) housed within the second shell 120. Additionally or alternatively, in certain instances, the first shell 110 can include at least one socket connection and the second shell 120 can include at least one pin connection. Exemplary electrical contacts 101, e.g. pins and sockets, are depicted in shells 110′ and 120′ of a circular connector 100′ in FIG. 11. The electrical contacts 101 are supported within electrically insulative housings 103. The circular connector 100′ can be similar in many respects to the circular connector 100. The reader will readily appreciate that the circular connectors 100 and 101′ can also be used with different types and/or numbers of electrical contacts, as well as various different arrangements thereof.

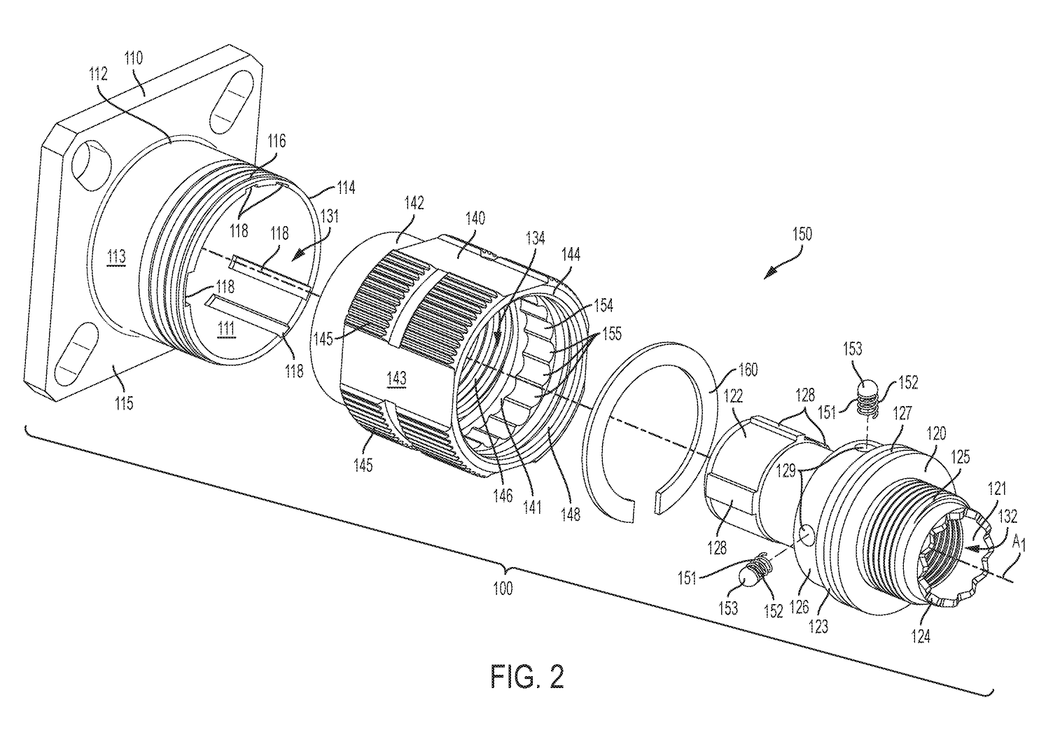

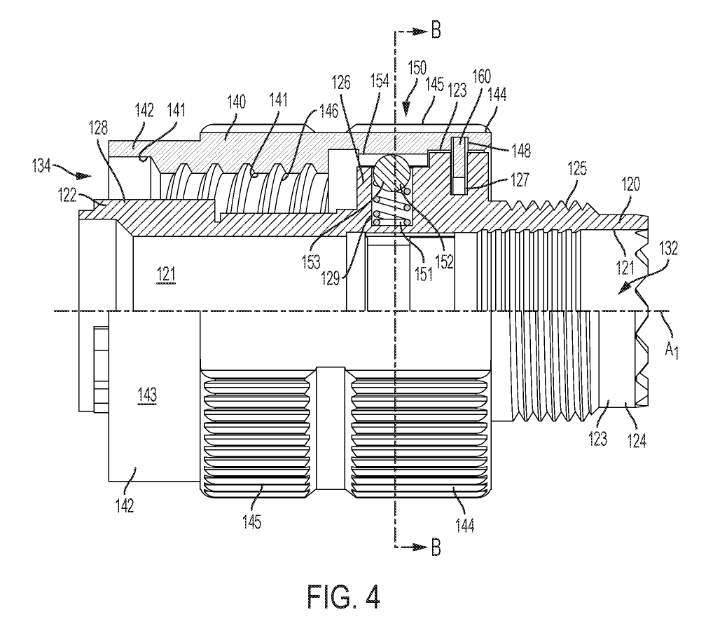

As described in greater detail herein, the coupling nut 140 can be secured to one of the first shell 110 or the second shell 120, and can threadably engage the other of the first shell 110 or the second shell 120. Referring to FIG. 4, for example, the coupling nut 140 is secured to the second shell 120. Moreover, the coupling nut 140 is configured to threadably engage the first shell 110 (FIGS. 1 and 2) when secured to the second shell 120 to couple the first and second shells 110, 120. In such instances, internal threads 146 of the coupling nut 140 can threadably engage external threads 116 of the first shell 110, and coupling rotation of the coupling nut 140 relative to the first shell 110 can draw the first shell 110 axially along a central axis A₁ toward the second shell 120. Moreover, decoupling rotation of the coupling nut 140 relative to the first shell 110 can draw the first shell 110 axially away from the second shell 120 along the central axis A₁.

The circular connector 100 includes an anti-decoupling mechanism 150. The anti-decoupling mechanism 150 includes features on the second shell 120 and features on the coupling nut 140, which interact to increase friction between the components and resist relative rotation. For example, the anti-decoupling mechanism 150 includes a plurality of detent assemblies 152 housed at least partially in the second shell 120 and a grooved or toothed surface 154 in the coupling nut 140. The detent assemblies 152 are biased into frictional engagement with the grooved surface 154 to resist rotation between the second shell 120 and the coupling nut 140. Because rotation between the coupling nut 140 and the second shell 120 is restrained and/or controlled by the anti-decoupling mechanism 150, the circular connector 100 can resist the decoupling of the first shell 110 and the second shell 120 even when subjected to extreme conditions, such as high-vibration environments. More specifically, when the first shell 110 and the second shell 120 are connected, as described in greater detail herein, the shells 110, 120 may not be permitted to rotate independently, but rather, can rotate together. In such instances, restrained rotation of the coupling nut 140 relative to the second shell 120 corresponds to restrained rotation of the coupling nut 140 relative to the first shell 110 and, as a result, decoupling rotation of the coupling nut 140 relative to the first shell 110 is restrained via the engagement between the coupling nut 140 and the second shell 120. The anti-decoupling mechanism 150 is further described herein.

Referring primarily to FIG. 2, the first shell 110 includes a first end 112 and a second end 114. The first shell 110 includes an outer surface 113, an inner surface 111, and a central bore 131 defined by the inner surface 111 and extending along the central axis A₁. An externally-threaded portion or external threads 116 of the first shell 110 is positioned on the outer surface 113 at and/or near the second end 114, and an attachment portion 115 is positioned at and/or near the first end 112. The attachment portion 115 can be configured to attach the first shell 110 to another structure and/or electrical device, for example. The attachment portion 115 is an attachment flange. In certain instances, the attachment portion 115 can be threaded and/or can include other fastening or attachment features, such as a bracket, screw holes, and/or apertures, for example.

The second shell 120 includes a first end 122, a second end 124, and an attachment portion 125 positioned at and/or near the second end 124. The second shell 120 also includes an outer surface 123, an inner surface 121, and a central bore 132 defined by the inner surface 121 and extending along the central axis A₁. The attachment portion 125 is configured to attach the second shell 120 to another structure and/or electrical device, for example. The attachment portion 125 is a threaded portion of the outer surface 123. In certain instances, the attachment portion 125 can include other fastening or attachment features, such as a bracket, screw holes, and/or apertures, for example.

In various instances, the first shell 110 and the second shell 120 can include alignment features configured to align the shells 110, 120 and the electrical contacts housed therein. Such alignment features can prevent relative rotation between the shells 110, 120. For example, the first shell 110 includes alignment features, or keyways, 118 (FIG. 2) on the inner surface 111. The alignment features 118 extend from at and/or near the second end 114 toward the first end 112 and are structured, dimensioned and positioned to mate with corresponding alignment features, or alignment keys, 128 (FIG. 2) on the outer surface 123 of the second shell 120. Mating engagement between the alignment features 118 and 128 can guide and/or facilitate axial alignment and connection of the first shell 110 and the second shell 120. For example, the alignment feature 118 can include at least one longitudinal and/or axially extending notch or keyway and the alignment feature 128 can include at least one longitudinal and/or axially extending rib or key. The keys 128 on the second shell 120 can slide into the keyways 118 on the first shell 110 to prevent rotation between the first shell 110 and the second shell 120, for example.

Additionally or alternatively, the first shell 110 can include at least one rib and the second shell 120 can include at least one notch, for example. The reader will appreciate that various styles and/or arrangements of alignment features can be utilized to prevent rotation between the first shell 110 and the second shell 120 and that suitable variations are applicable to the circular connectors described herein.

In certain instances, a biasing sleeve can be positioned around the second shell 120. The ends of the biasing sleeve can be connected by a clip, such that the biasing sleeve is securely positioned around the second shell 120. For example, the biasing sleeve can be positioned around the second shell 120 intermediate the alignment features 128 and an annular flange 126 of the second shell 120 that houses the detent assemblies 152. When the first shell 110 and the second shell 120 are assembled, the biasing sleeve can be positioned therebetween and can frictionally engage the first shell 110 and the second shell 120 to further prevent and/or limit relative movement between the first shell 110 and the second shell 120. A biasing sleeve can be comprised of metal, such as a beryllium copper alloy, for example. In other instances, a biasing sleeve can be comprised of additional and/or different metallic materials and/or non-metallic materials. Exemplary biasing sleeves are described in U.S. Pat. No. 9,531,120, which is incorporated by reference herein in its entirety.

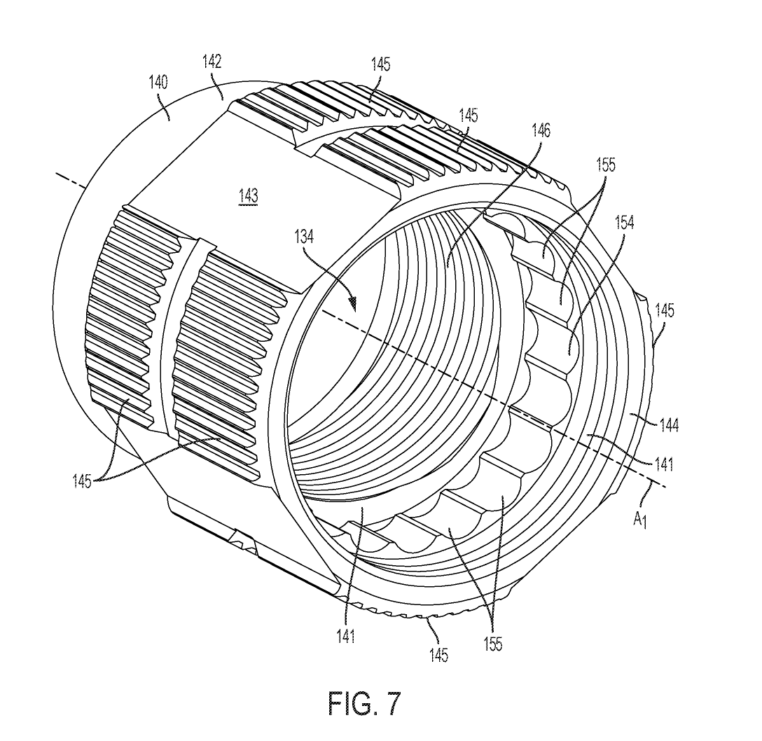

Referring primarily to FIGS. 2 and 7, the coupling nut 140 can include a first end 142, second end 144, an outer surface 143, an inner surface 141, and a central bore 134 defined by the inner surface 141 and extending along the central axis A₁. An internally threaded portion or internal threads 146 can be positioned on the inner surface 141 and can extend from at and/or near the first end 142 toward the second end 144. The internal threads 146 can threadably engage the external threads 116 on the first shell 110, for example, to draw the second shell 120 toward the first shell 110. In various instances, the coupling nut 140 can include at least one gripping portion or grip 145 on the outer surface 143, which can facilitate manual rotation of the coupling nut 140. For example, a plurality of gripping portions 145 are positioned around the outer surface 143 of the coupling nut 140 and can be gripped by a technician to rotate the coupling nut 140.

The second shell 120 can also include at least one locking feature for securing the second shell 120 relative to the coupling nut 140. Such a locking feature can be configured to engage the coupling nut 140 to secure the second shell 120 relative to the coupling nut 140 while permitting rotation of the second shell 120 relative to the coupling nut 140. For example, a locking ring or retainer 160 intermediate the second shell 120 and the coupling nut 140 can be configured to hold the coupling nut 140 axially around the second shell 120 while permitting relative rotation therebetween.

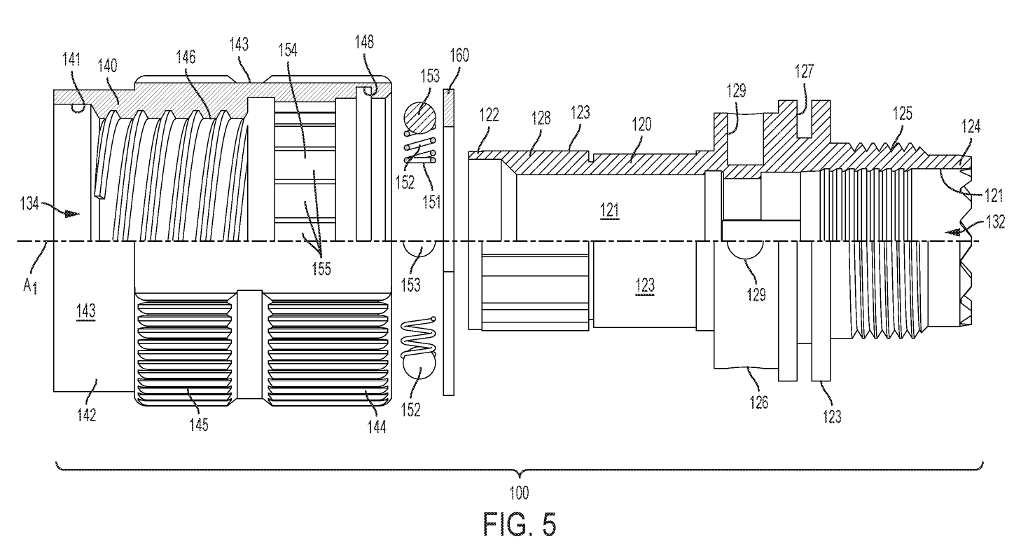

Referring primarily to FIGS. 4 and 5, the second shell 120 includes an annular flange 126 intermediate the first end 122 and the attachment portion 125. The annular flange 126 includes an annular recess 127 protruding inwardly from the outer surface 123. The annular recess 127 is dimensioned, structured, and positioned to receive at least a portion of the locking ring 160. In various instances, the locking ring 160 can define a semi-annular spring, which can be deformed or compressed to fit within, or substantially within, the annular recess 127. For example, the locking ring 160 can be a “C”-shaped spring. The coupling nut 140 also includes an annular recess 148 which protrudes outwardly from the inner surface 141 and is dimensioned, structured, and positioned to receive at least a portion of the locking ring 160. The locking ring 160 can be deformed or expanded to fit within, or substantially within, the annular recess 148, for example.

When the coupling nut 140 and the second shell 120 are assembled, as in FIG. 4, the locking ring 160 can be retained within both annular recesses 127 and 148. As further described herein, the locking ring 160 can be biased into the annular recess 127 while the coupling nut 140 moves over the second shell 120 from a disengaged position to an engaged position. As the coupling nut 140 moves between the disengaged position and the engaged position, the locking ring 160 can exert a spring back force on the inner surface 141 of the coupling nut 140. Moreover, when the annular recesses 127 and 148 are aligned, as depicted in FIG. 4, the locking ring 160 can extend into the annular recess 148 as it resumes, or seeks to resume, its undeformed configuration. The locking ring 160 engages the annular recesses 127 and 148 to prevent axial displacement or translation of the coupling nut 140 relative to the second shell 120.

Additionally or alternatively, the second shell 120 and the coupling nut 140 can be snap-fit together. A snap-fit connection can ensure that the coupling nut 140 is secured around the second shell 120 while rotation of the coupling nut 140 relative to the second shell 120 is permitted. For example, an annular or semi-annular feature of the coupling nut 140 can snap around a sloped locking rib on the second shell 120 to rotatably couple the coupling nut 140 to the second shell. Exemplary snap-fit arrangements are described in U.S. Pat. No. 9,531,120, which is incorporated by reference herein in its entirety.

The anti-decoupling mechanism 150 includes the detent assemblies 152 and the grooved surface 154. The geometric relationship between the detent assemblies 152 and the grooved surface 154 controls the rotational resistance provided by the anti-decoupling mechanism 150 and, thus, dictates the torques required to couple and decouple the circular connector 100. Referring primarily to FIG. 9, the anti-decoupling mechanism 150 is four-fold rotationally symmetric about a central axis A₁ of the circular connector 100 and bilaterally symmetric about axes A₂ and A₃. The axes A₁, A₂, and A₃ are mutually orthogonal axes. The symmetry of the anti-decoupling mechanism provides a coupling-to-decoupling torque ratio of 1:1 or substantially 1:1. Stated differently, the torque required to couple the circular connector 100 is equal, or substantially equal, to the torque required to decouple the circular connector 100. In various instances, the coupling and decoupling torque can be 2.6 lbf-in. In other instances, the coupling and decoupling torques can be greater than or less than 2.6 lbf-in. For example, the coupling and decoupling torques can be between 1 lbf-in and 4 lbf-in.

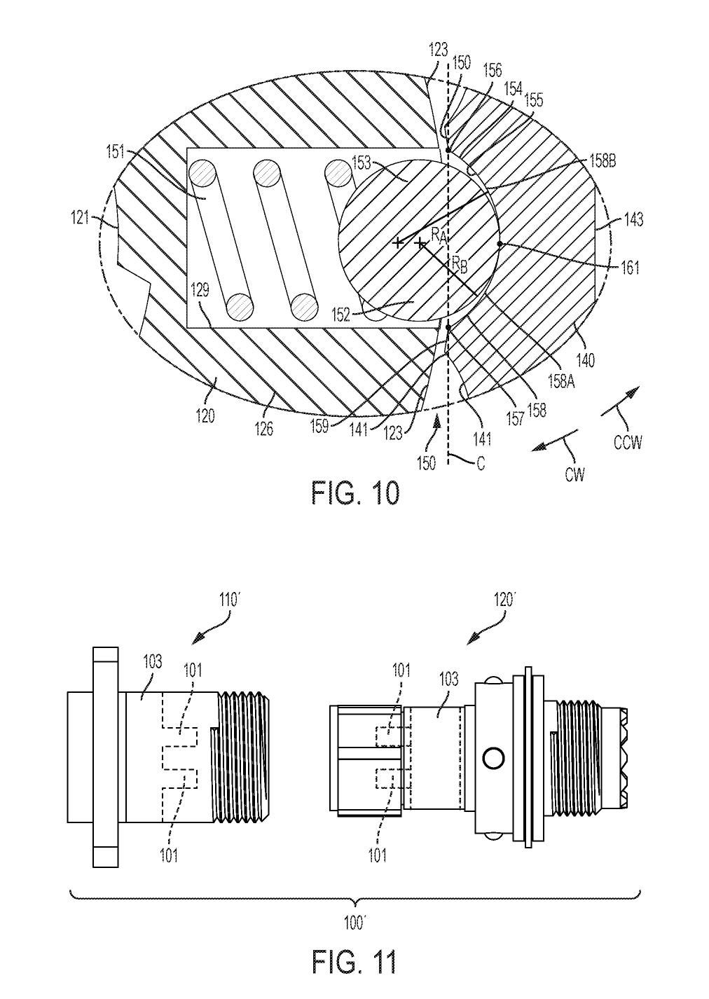

The second shell 120 includes a plurality of apertures or bores 129 defined radially into the outer surface 123 on a portion of the annular flange 126. The bores 129 are positioned intermediate the annular recess 127 and the first end 122. Each bore 129 houses a detent assembly 152 that includes a coil spring 151 and a ball bearing 153. Referring primarily to FIG. 10, the ball bearings 153 are spherical and comprise a constant radius of curvature R_{B}. The radius of curvature R_{B} can be 0.039 inches, for example. In other instances, the radius of curvature R_{B} can be more than 0.039 inches or less than 0.039 inches. For example, the radius of curvature R_{B} can be 0.039 inches ±25%. In still other instances, the radius of curvature R_{B} can be 0.039 inches ±50% for example.

The coil spring 151 is a cylindrical compression spring formed from a round metal wire, such as a stainless steel wire having a diameter of 0.0140 inches ±0.0004 inches, for example. The coil spring 151 is configured to exert an outward biasing force on the ball bearing 153 when the coil spring 151 is compressed. Referring primarily to FIG. 9, four bores 129 are defined into the outer surface 123. The coil springs 151 can have a spring rate or spring constant of 90 lbf/in. In certain instances, the coil springs 151 can have a spring rate of less than or more than 90 lbf/in. For example, the coil springs 151 can have a spring rate of 90 lbf/in ±25% or 90 lbf/in ±50%. The reader will readily appreciate that alternative spring geometries can be employed to bias the ball bearings outward and achieve the desired spring rate.

The four bores 129 are equidistantly-spaced around the perimeter of the annular flange 126. In other words, the bores 129 are rotationally offset by ninety degrees about the second shell 120. Moreover, the detent assemblies 152 are four-fold rotationally symmetric about the central axis A₁ of the circular connector 100 and bilaterally symmetric about the mutually orthogonal axes A₂ and A₃.

The bores 129 can be machined into the second shell 120. For example, a drill or other cutting tool can cut the bores 129 into the second shell 120 from the outer surface 123. Because the bores 129 extend radially inward from the outer surface 123, manufacturing the second shell 120 and machining the bores 129 therein can be easier and, thus, more cost effective, than machining an outwardly extending bores from the inner surface 141 of the coupling nut 140, for example.

The coil springs 151 bias the ball bearings 153 radially outward into engagement with the grooved surface 154 on the inside of the coupling nut 140. Friction between the ball bearings 153 and the grooved surface 154 is configured to resist rotation of the coupling nut 140 relative to the shells 110, 120. The grooved surface 154 extends along an annular or ring-shaped track portion of the inner surface 141 within the coupling nut 140. The grooved surface 154 includes a plurality of axial grooves or teeth 155 defined around the radius of the coupling nut 140. The axial grooves 155 undulate inward and outward radially around the inner surface 141 of the coupling nut 140 and extend along axial paths or tracks through the coupling nut 140.

Referring primarily to FIG. 10, each axial groove 155 includes a first end 156, a second end 157, and an arced or bowed profile 158 extending between the first end 156 and the second end 157. The first end 156 extends along a first axis that is parallel to the central axis A₁, and the second end 157 extends along a second axis that is also parallel to the central axis A₁. The arced profiles 158 have a uniform curvature and a constant radius of curvature R_{A}. The radius of curvature R_{A} can be 0.050 inches, for example. In other instances, the radius of curvature R_{A} can be more than 0.050 inches or less than 0.05 inches. For example, the radius of curvature R_{A} can be 0.050 inches ±25%. In still other instances, the radius of curvature R_{A} can be 0.050 inches ±50%.

Each arced profile 158 defines an entry portion 158A and an exit portion 1586. The entry and exit portions 158A and 1586 correspond to a coupling rotation of the coupling nut 140. For example, when the coupling nut 140 is rotated in a coupling direction, e.g. clockwise (“CW”), the ball bearing 153 enters the axial groove 155 along the entry portion 158A and exits the axial groove 155 along the exit portion 158B. In other instances, the entry and exit portions 158A and 1586 can correspond to a decoupling rotation, e.g. counterclockwise (“CCW”) of the coupling nut 140. The entry portion 158A and the exit portion 158B of each axial groove 155 are bilaterally symmetric about the inflection point 161 of the arced profile 158.

Referring still to FIG. 10, the grooved surface 154 is devoid of vertical sidewalls. For example, the grooved surface 154 transitions between the curvature of an axial groove 155 to a face or surface 159 and to another axial groove 155 without any vertical sidewalls within the axial grooves 155 or intermediate adjacent axial grooves 155. Along the profile of the grooved surface 154, a tangent to the grooved surface 154 is obliquely oriented to the grooved surface 154. Stated differently, such tangents are not aligned with the radius of the circular connector 100. Because the grooved surface 154 is devoid of vertical sidewalls, less torque can be required to rotate the coupling nut 140 relative to the shells 110, 120 and the rotation can be smoother than arrangements that include vertical sidewalls. Although less torque may be required, rotation is still sufficiently restrained by the anti-decoupling mechanism 150 in compliance with MIL-DTL-38999M w/AMENDMENT 1, dated Jan. 26, 2017. Moreover, the reduced torque requirement can ensure that the circular connector 100 can be manually (i.e. by hand) coupled and decoupled as necessary.

It is unexpected that the torque requirements can be satisfied with the smoothly contoured profile of the grooved surface 154. More particularly, owing to the complementary smoothness of both the grooved surface 154 and the ball bearings 153, it is unexpected that the anti-decoupling mechanism 150 can generate sufficient friction to produce the appropriate resistance and torque. Nonetheless, satisfactory torque is generated by the anti-decoupling mechanism 150. For example, the spring force can be selected to maintain suitable frictional engagement between the grooved surface 154 and the ball bearings 153. The complementary smoothness advantageously enables an operator to manually rotate the coupling nut 140 in both the coupling and decoupling directions.

The radius of curvature R_{A} of the arced profiles 158 is greater than the radius of curvature R_{B} of the ball bearings 153. For example, the radius of curvature R_{A} of the arced profiles 158 is 0.011 inches greater than the radius of curvature R_{B} of the ball bearings 153. In other instances, the difference can be greater than 0.011 inches or less than 0.011 inches. In certain instances, the radius of curvature R_{A} of the arced profiles 158 can be 20-30% greater than the radius of curvature R_{B} of the ball bearings 153. In other instances, the difference the radius of curvature R_{A} of the arced profiles 158 can be less than 20% or more than 30% greater than the radius of curvature R_{B} of the ball bearings 153.

Referring still to FIG. 10, the profile of each axial groove 155 is a circle segment defined between the first end 156 and the second end 157. A chord C of the circle also extends between the first end 156 and the second end 157 of the arced profile 158 to form the circle segment boundary. The circle segments are minor segments comprising less than a semi-circular shape. In various instances, the profiles can comprise half-moon segments of a circle. Faces 159 are defined intermediate adjacent axial grooves 155. For example, a face 159 can extend from the end of one axial groove 155 to the beginning of an adjacent axial groove 155. In various instances, the faces 159 can define a profile that complements the outer surface 123 of the annular flange 126 on the second shell 120. Additionally or alternatively, the faces 159 can define flat surfaces or substantially flat surfaces between the axial grooves 155.

The geometry of the grooved surface 154 and the axial grooves 155 thereof is configured to minimize wear to the coupling nut 140 and the second shell 120. For example, the axial grooves 155 define a smooth contoured surface that sufficiently resists rotation while managing the shock or impact between the ball bearings 153 and the grooved surface 154 as the coupling nut 140 rotates. For example, the anti-decoupling mechanism 150 can be comprised of metal components including the ball bearings 153 and the grooved surface 154. A metal-on-metal relationship may be prone to increased wear, which would reduce the durability of a circular connector. However, the metal-to-metal connection between the ball bearings 153 and the grooved surface 154 is configured to provide a coupling and decoupling relationship in which the components smoothly and manually engage each other to minimize shocks thereto and, thus, stresses in the components. Moreover, a user can smoothly rotate the coupling nut 140 relative to the shells 110, 120 to couple and decouple the circular connector 100.

The grooved surface 154 on the inner surface of the coupling nut 140 is four-fold rotationally symmetric about the central axis A₁ of the circular connector 100 and bilaterally symmetric about the axes A₂ and A₃. The axes A₁, A₂, and A₃ are mutually orthogonal axes. Moreover, the axial grooves 155 are equidistantly spaced around the inside perimeter of the coupling nut 140. In certain instances, the grooved surface is n-fold rotationally symmetric where n is the number of axial grooves 155 depending on the size of the circle connector 100. Because there are four detent assemblies 152 in the second shell 120, the grooved surface can be n⁴-fold rotationally symmetric. For example, referring primarily to FIG. 9, the grooved surface 154 is twenty-fold rotationally symmetric about the central axis A₁. In other instances, the grooved surface 154 can include fewer or more than twenty axial grooves 155. For example, the grooved surface 154 can include twelve, sixteen, twenty-four, twenty-eight, thirty-two or thirty-six axial grooves 155. In other instances, the grooved surface 154 can include less than twelve or more than thirty-six axial grooves 155.

To assemble the circular connector 100, each detent assembly 152 is positioned within a bore 129 in the second shell 120. Assembly grease is used to hold the detent assemblies 152 within the bores 129. For example, assembly grease can coat a portion of the bore 129, coil spring 151, and/or ball bearing 153 to hold the detent assemblies 152 in place. The assembly grease is sufficiently lubricous and viscous such that it holds the coil springs 151 and the ball bearings 153 within the bores 129 during the assembly process. Moreover, the assembly grease can serve to lubricate the anti-decoupling mechanism 150 and interfaces thereof. For example, a high performance synthetic grease such as TRIBOLUBE®-2N can be used.

After the detent assemblies 152 are secured within the bores 129, the second shell 120 is positioned within the coupling nut 140. To hold the second shell 120 within the coupling nut 140, the locking ring 160 is disposed therebetween. In particular, the locking ring 160 is compressed within the annular recess 127 in the second shell 120 such that the perimeter of the locking ring 160 is reduced to less than the inside diameter of the coupling nut 140. For example, a funnel tool can be utilized to reduce the diameter of the locking ring 160 while the coupling nut 140 is positioned over the second shell 120.

Referring primarily to FIG. 12, an exemplary funnel tool 180 is depicted. The funnel tool 180 is an annular member having a first end 182, a second end 184, and a funneled aperture 186 narrowing from the first end 182 toward the second end 184. The funnel tool 180 also includes an annular shoulder 188 between the funneled aperture 186 and the second end 184. To assemble the coupling nut 140 and the second shell 120, the locking ring 160 is positioned within the annular recess 127 in the second shell 120 and the funnel tool 180 is positioned around the coupling nut 140 such that the first end 142 of the coupling nut 140 abuts the annular shoulder 188 of the funnel tool 180. Thereafter, the second shell 120 is moved along the central axis A₁ toward the funnel tool 180. As the second shell 120 moves through the funneled aperture 186 of the funnel tool 180, the locking ring 160 moves along the surface of the funneled aperture 186 such that the locking ring 160 is further compressed within the annular recess 127. The funnel tool 180 compresses the locking ring 160 within the inside diameter of the coupling nut 140. As the second shell 120 continues to move along the central axis A₁, the annular recess 148 in the coupling nut 140 moves into alignment with the annular recess 127 in the second shell 120 and the locking ring 160 is configured to spring into engagement with the annular recess 148, which prevents axial movement of the assembled coupling nut 140 and second shell 120. As the second shell 120 moves into locking engagement with the coupling nut 140, the detent assemblies 152 are also compressed and then spring into engagement with the grooved surface 154 of the coupling nut 140. The funnel tool 180 is removed from the coupling nut 140 after the locking ring 160 is seated in the annular recess 148.

Referring primarily to FIG. 2, after the detent assemblies 152 are positioned within the bores 129 and held therein with assembly grease, for example, the circular connector 100 consists of four components: the first shell 110, the second shell 120, the coupling nut 140, and the locking ring 160. The four components can be quickly and easily assembled as described herein. Because the circular connector 100 is comprised of fewer parts than other circular connectors, the assembly thereof can be straightforward and, thus, can be completed at a reduced cost. Moreover, minimal force is required to assemble these four components. Once assembled, the circular connector 100 comprises a robust and durable assembly that is configured to withstand repeated uses in high friction environments. For example, the circular connector 100 has been tested to withstand at least 500 cycles of mating and unmating without showing any signs of excessive wear or any defects detrimental to the operation of the circular connector 100.

In use, the coupling nut 140 can be rotated about the shells 110, 120. In particular, the alignment features 118 and 128 maintain alignment of the shells 110 and 120, while the coupling nut 140 rotates about the second shell 120 to threadably engage the first shell 110. In particular, the internal threads 146 on the coupling nut 140 are configured to threadingly engage the external threads 116 on the first shell 110. The coupling nut 140 can be rotated in a clockwise (“CW”) direction to couple the coupling nut 140 and the first shell 110. In other instances, the counterclockwise (“CCW”) direction can correspond to a coupling direction, and the clockwise direction can correspond to a decoupling direction. As the coupling nut 140 is rotated about the shells 110, 120, the grooved surface 154 is configured to ride along the detent assemblies 152. The detent assemblies 152 are subjected to a compressive force by the grooved surface 154 and the coil springs 151 thereof are compressed to accommodate the undulations of the grooved surface 154 as the coupling nut 140 is rotated. As the coupling nut 140 is rotated relative to the shells 110, 120, the anti-decoupling mechanism 150 is configured to generate feedback. For example, the anti-decoupling mechanism 150 can provide tactile and/or auditory feedback as the detent assemblies 152 click into engagement with the axial grooves 155.

The detent assemblies 152 act as detents which engage the grooved surface 154 to resist rotation of the coupling nut 140 relative to the shells 110, 120. For example, when the coupling nut 140 is rotated in a coupling direction, e.g. a clockwise direction, the ball bearings 153 move along the exit portions 1586 of the axial grooves 155, which compresses the coil springs 151 and generates increased friction and rotational resistance. From the exit portions 158B, the ball bearings 153 move along a face 159 and then down the entry portion 158A of an adjacent axial groove 155. The coil springs 151 bias the ball bearings 153 outward such that the ball bearings 153 spring into the axial grooves and rest at the apex or inflection point 161 thereof. A minimum torque is required to compress the coil springs 151 and move the ball bearing 153 along the exit portion 158B of each axial groove 155. The minimum torque can be obtainable by hand, e.g., by manually rotating the coupling nut 140 relative to the shells 110, 120. Similarly, when the coupling nut 140 is rotated in a decoupling direction, e.g. a counterclockwise direction, the ball bearings 153 move along the entry portions 158A of the axial grooves 155, which compresses the coil springs 151 and generates rotational resistance. From the entry portions 158A, the ball bearing 153 move along a face 159 and then down the exit portions 158B of the adjacent axial grooves 155. The coil springs 151 bias the ball bearings 153 outward such that the ball bearings 153 spring into the adjacent axial grooves and rest at the apex or inflection point 161 thereof. A minimum torque is required to compress the coil springs 151 and move the ball bearing 153 along the entry portion 158A of each axial groove 155. Because the axial grooves 155 define a uniform curvature from end to end such that the entry and exit portions 158A, 158B are bilaterally symmetric about the apex 161, rotation of the coupling nut 140 relative to the shells 110, 120 is restrained equally, or substantially equally, in the coupling and decoupling directions. More specifically, the coupling-to-decoupling torque ratio is 1:1 or substantially 1:1. In certain instances, the coupling torque can differ from the decoupling torque by less than 25%. For example, the coupling torque and decoupling torque can differ by 5% or 10%.

Numerous specific details are set forth herein to provide a thorough understanding of the overall structure, function, manufacture, and use of the embodiments as described in the specification and illustrated in the accompanying drawings. Well-known operations, components, and elements have not been described in detail so as not to obscure the embodiments described in the specification. The reader will understand that the embodiments described and illustrated herein are non-limiting examples, and thus it can be appreciated that the specific structural and functional details disclosed herein may be representative and illustrative. Variations and changes thereto may be made without departing from the scope of the claims.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements, but is not limited to possessing only those one or more elements. Likewise, an element of a system, device, or apparatus that “comprises,” “has,” “includes” or “contains” one or more features possesses those one or more features, but is not limited to possessing only those one or more features.

Although various devices have been described herein in connection with certain embodiments, modifications and variations to those embodiments may be implemented. Particular features, structures, or characteristics may be combined in any suitable manner in one or more embodiments. Thus, the particular features, structures, or characteristics illustrated or described in connection with one embodiment may be combined in whole or in part, with the features, structures or characteristics of one ore more other embodiments without limitation. Also, where materials are disclosed for certain components, in certain instances, other materials may be used. Furthermore, in certain instances , a single component may be replaced by multiple components, and/or multiple components may be replaced by a single component, to perform a given function or functions. The foregoing description and following claims are intended to cover all such suitable modification and variations.

While this invention has been described as having exemplary designs, the present invention may be further modified within the spirit and scope of the disclosure. This application is therefore intended to cover any variations, uses, or adaptations of the invention using its general principles.

Any patent, publication, or other disclosure material, in whole or in part, that is said to be incorporated by reference herein is incorporated herein only to the extent that the incorporated materials do not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

1. An electrical connector, comprising:
a first shell comprising a first alignment portion and an external threaded surface;
a coupling nut, comprising:
an internal threaded surface structured to threadably engage the external threaded surface of the first shell; and
an internal grooved surface comprising a plurality of axial grooves, wherein the axial grooves define a constant radius of curvature; and
a second shell, comprising:
a second alignment portion structured to engage the first alignment portion to prevent rotation of the second shell relative to the first shell; and
a plurality of detent assemblies equidistantly-spaced around the second shell, wherein each detent assembly comprises a ball bearing and a coil spring, and wherein the coil springs are positioned to bias the ball bearings outwardly into engagement with the internal grooved surface of the coupling nut, wherein the ball bearings and the internal grooved surface are metallic.

2. The electrical connector of claim 1, wherein the first shell further comprises a plurality of first electrical contacts, and wherein the second shell further comprises a plurality of second electrical contacts dimensioned and positioned to mate with the plurality of first electrical contacts.

3. The electrical connector of claim 2, wherein the first shell comprises a socket, and wherein the second shell comprises a plug.

4. (canceled)

5. The electrical connector of claim 1, wherein the internal grooved surface is four-fold rotationally symmetric about a first axis and reflectively symmetric about a second axis and a third axis, and wherein the first axis, the second axis, and the third axis are mutually orthogonal.

6. The electrical connector of claim 1, wherein the coupling nut further comprises a first annular recess, wherein the second shell further comprises a second annular recess aligned with the first annular recess, and wherein the electrical connector further comprises a locking ring positioned in the first annular recess and the second annular recess.

7. An electrical connector, comprising:
a first shell comprising an external threaded portion;
a second shell comprising an outer surface, wherein a plurality of apertures are defined in the outer surface;
a coupling nut comprising an internal threaded portion structured to threadably engage the external threaded portion of the first shell; and
a metal-on-metal anti-decoupling mechanism, comprising:
an internal grooved surface defined on the coupling nut; and
a plurality of detent assemblies, wherein one of the detent assemblies is positioned in each aperture, and wherein the detent assemblies are biased outwardly into engagement with the internal grooved surface;
wherein the metal-on-metal anti-decoupling mechanism is four-fold rotationally symmetric about a first axis and reflectively symmetric about a second axis and a third axis, and wherein the first axis, the second axis, and the third axis are mutually orthogonal.

8. The electrical connector of claim 7, wherein the metal-on-metal anti-decoupling mechanism comprises:
a coupling force to rotate the coupling nut relative to the first shell in a first direction; and
a decoupling force to rotate the coupling nut relative to the first shell in a second direction, and wherein the decoupling force is equal to the coupling force.

9. The electrical connector of claim 7, wherein the internal grooved surface comprises a plurality of axial grooves and a plurality of surfaces intermediate adjacent axial grooves, and wherein the axial grooves comprise a constant radius of curvature.

10. The electrical connector of claim 7, wherein the first shell further comprises a plurality of first electrical contacts, and wherein the second shell further comprises a plurality of second electrical contacts dimensioned and positioned to mate with the plurality of first electrical contacts.

11. The electrical connector of claim 7, further comprising an alignment feature intermediate the first shell and the second shell.

12. An electrical connector, consisting of:
a first component comprising an external threaded portion;
a second component, comprising:
an outer surface, wherein a plurality of apertures are defined in the outer surface; and
a plurality of detents, wherein the detents are housed in the apertures;
a third component, comprising:
an internal threaded portion structured to threadably engage the external threaded portion of the first component; and
an internal grooved portion comprising a plurality of axial grooves, wherein the axial grooves are defined by an arc having a constant groove radius of curvature, and wherein the plurality of detents are rotatably aligned with the axial grooves; and
a fourth component positioned intermediate the second component and the third component.

13. The electrical connector of claim 12, wherein each detent comprises a spring and a ball bearing.

14. The electrical connector of claim 13, wherein each ball bearing comprises a constant ball radius of curvature, and wherein the constant ball radius of curvature is less than the constant groove radius of curvature.

15. The electrical connector of claim 12, wherein the plurality of apertures consists of four apertures equidistantly-spaced around the outer surface.

16. The electrical connector of claim 12, wherein the first component further comprises an inner surface comprising a plurality of first alignment features, wherein the outer surface of the second component further comprises a plurality of second alignment features, and wherein the second alignment features are dimensioned to engage the first alignment features to resist rotation of the first component relative to the second component.

17. The electrical connector of claim 12, wherein the first component further comprises a plurality of first electrical contacts, and wherein the second component further comprises a plurality of second electrical contacts dimensioned and positioned to mate with the plurality of first electrical contacts.

18. The electrical connector of claim 12, wherein the first component, the second component, the third component, and the fourth component are comprised of metal.

19. The electrical connector of claim 12, wherein the internal grooved portion further comprises a plurality of faces, and wherein each face is positioned intermediate adjacent axial grooves.

20. The electrical connector of claim 12, wherein the fourth component comprises a locking ring configured to limit axial displacement of the third component relative to the second component.

21. A method of assembling an electrical connector, comprising:
aligning a funnel tool with a central bore of a coupling nut, wherein the coupling nut comprises a first annular recess defined radially outward from the central bore;
applying assembly grease to a second shell having a plurality of apertures and a second annular recess defined radially inward from an outer surface;
positioning a detent assembly in each aperture;
positioning a locking ring in the second annular recess;
moving the second shell and the locking ring through the funnel tool and into the coupling nut until the first annular recess is aligned with the second annular recess such that the locking ring moves into engagement with the first annular recess.

22. The method of claim 21, further comprising threadably coupling the second shell to a first shell.
